(19) United States
(12) Patent Application Publication
(10) Pub. No.: US 2026/0350179 A1
(43) Pub. Date: Nov. 5, 2026

(54) DETECTING VULNERABILITIES IN CODE COMMITS UTILIZING GENERATIVE MODEL AGENTS

(71) Applicant: OpenAI OpCo, LLC, San Francisco, CA (US)

(72) Inventors: David Aitel, Miami Beach, FL (US); Akshay Bhat, New York, NY (US); Matthew Knight, San Francisco, CA (US)

(21) Appl. No.: 19/364,425

(22) Filed: Oct. 21, 2025

Related U.S. Application Data
(60) Provisional application No. 63/798,122, filed on May 1, 2025.

(51) Int. Cl. G06F 21/57; G06F 8/71; H04L 41/16

(52) U.S. Cl. CPC G06F 21/577; G06F 8/71; H04L 41/16; G06F 2221/033

(57) ABSTRACT

The present disclosure relates to systems, non-transitory computer-readable media, and methods for analyzing vulnerabilities within computer code. The disclosed systems can retrieve, by a generative artificial intelligence (AI) system, a commit from a codebase storing commits defining computer code changes saved for a computer application. In one or more cases, the disclosed systems can generate, utilizing a large language model, a threat model comprising a structured data object defining vulnerability parameters of computer code corresponding to the computer application. Additionally, the disclosed system can generate, by analyzing the commit and the threat model together utilizing a generative threat analysis agent, a threat object indicating threat data associated with the commit.

### CROSS-REFERENCE TO RELATED APPLICATIONS

This application claims priority to and the benefit of U.S. Provisional Patent Application No. 63/798,122, filed on May 1, 2025, which is incorporated herein by reference in its entirety.

### BACKGROUND

Recent years have seen significant development in training and utilizing machine learning models to identify security threats and data vulnerabilities within computer code. For example, some conventional systems can analyze source code to identify weaknesses or bugs that are either inadvertent or the result of malicious actors. Some existing systems employ large language models to scan computer code for common patterns or known bugs. Despite these advances, existing systems continue to exhibit a number of disadvantages, particularly in terms of data security, flexibility, and computing efficiency.

As just suggested, some existing systems are insecure. For example, some conventional systems analyze vulnerabilities within computer code by processing the code base directly in the control plane of the system. Such methods risk leaking sensitive data and/or compromising the integrity of the system. For example, mixing code analysis with control plane functions can contaminate the decision-making of large language models, leading to inaccurate security analysis and increased risk of faulty code. Moreover, because some conventional systems are often designed for, and fixed to, single codebases and programming languages, such systems either miss or incorrectly label vulnerabilities across different codebases or languages.

As just suggested, some existing systems are inflexible. For example, some conventional systems utilize static analysis tools that scan entire repositories based on manually configured triggers. Such traditional approaches require individual tuning and/or hard-coded rules for each programming language, framework, and/or application type of computer code, effectively siloing these systems on a per-language,-framework, or -application basis. Additionally, the reliance on brittle parsers and abstract syntax trees prevents some existing systems from effectively analyzing vulnerabilities in heterogeneous codebases.

On top of being insecure and inflexible, some conventional systems are computationally inefficient. In particular, some existing systems often re-scan large codebases in their entirety for each commit. Such redundant scanning often leads to excessive runtimes, wasted computational resources (e.g., processing power and memory), and poor scalability in analysis pipelines.

### SUMMARY

This disclosure describes systems, methods, and non-transitory computer-readable media for applying generative artificial intelligence to improve the security analysis of computer code. In particular, the disclosed systems can retrieve a commit representing code changes in a computer application from a codebase. In one or more embodiments, the disclosed systems can utilize a large language model to generate a threat model in the form of a structured data object that defines vulnerability parameters relevant to the codebase. A generative threat analysis agent then analyzes the commit together with the threat model to produce a threat object that identifies threat data associated with the commit, thereby providing an intelligent and adaptive mechanism for detecting security issues within evolving codebases.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a high-level architecture of a generative AI system in accordance with one or more embodiments.

FIG. 2 illustrates a schematic diagram of an example environment of a vulnerability detection system in accordance with one or more embodiments.

FIG. 3 illustrates an example overview of a vulnerability detection system generating a threat object in accordance with one or more embodiments.

FIG. 4 illustrates a vulnerability detection system generating a threat model in accordance with one or more embodiments.

FIG. 5 illustrates a vulnerability detection system resolving merge commits in accordance with one or more embodiments.

FIGS. 6A-6B illustrate a vulnerability detection system generating a threat object by analyzing a commit within an isolated container in accordance with one or more embodiments.

FIG. 7 illustrates a vulnerability detection system validating a threat object utilizing a validation agent in accordance with one or more embodiments.

FIG. 8 illustrates an exemplary graphical user interface in accordance with one or more embodiments.

FIG. 9 illustrates an example series of acts performed by a vulnerability detection system in accordance with one or more embodiments.

FIG. 10 illustrates a block diagram of an exemplary computing device in accordance with one or more embodiments.

FIG. 11 illustrates an example environment of a networking system having a vulnerability detection system in accordance with one or more embodiments.

### DETAILED DESCRIPTION

This disclosure describes one or more embodiments for a vulnerability detection system that can detect vulnerabilities in computer code by analyzing commits reflecting changes to the computer code. For example, the computer code associated with a computer application can receive one or more user inputs modifying the computer code. In one or more cases, such changes can lead to bugs or other inconsistencies that potentially create and/or expose vulnerabilities within the computer code and the computer application to bad actors and/or agents. In some cases, disclosed systems can store modifications to the computer code as commits in a codebase. The vulnerability detection system can retrieve a commit from the codebase and analyze the commit with a threat model. In one or more cases, the vulnerability detection system can generate the threat model utilizing a large language model to determine or define vulnerability parameters of the threat model that correspond to the computer code of the computer application. The vulnerability detection system can generate a threat object outlining the vulnerabilities and/or threats to the computer code by analyzing the commit and the threat model, with a generative threat analysis agent. In one or more cases, the threat object can aid in triaging and mitigating bugs that lead to vulnerabilities.

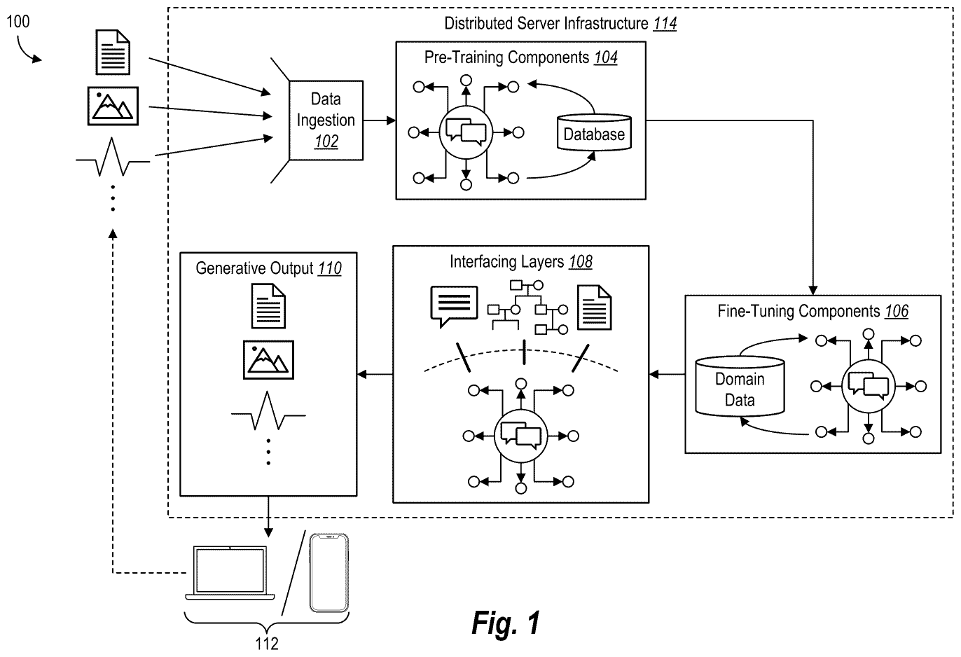

FIG. 1 illustrates a high-level architecture of a generative artificial intelligence (“AI”) system 100 for implementing large language models and other generative models to enable natural language processing, conversational interfaces, multimodal content generation, and analysis in accordance with one or more embodiments. The generative AI system 100 may include data ingestion pipelines 102, pre-training components 104, fine-tuning components 106, interfacing layers 108, and supporting hardware in the form of a distributed server infrastructure 114.

The data ingestion pipelines 102 of the generative AI system 100 may receive and preprocess large volumes of structured and unstructured data, including text corpora, image datasets, video datasets, and audio datasets, to support diverse generative model training. Preprocessing may include deduplication, tokenization, normalization, feature extraction (e.g., spectrogram generation for audio), and content safety filtering, preparing data for effective distributed training across server devices.

The pre-training components 104 of the generative AI system 100 may utilize transformer-based architectures for LLMs, as well as additional generative models such as diffusion models for image generation, autoencoders for representation learning, and multimodal transformer models for cross-domain generation tasks. These models may be configured with deep neural network stacks to capture hierarchical, semantic, and contextual relationships within the data.

The generative AI system 100 may employ diffusion models for image and video generation, where the models learn to iteratively denoise random noise into structured outputs conditioned on textual or other modality inputs. The generative AI system 100 may train these models using score-based or denoising diffusion probabilistic methods across distributed server devices within the distributed server infrastructure 114.

The generative AI system 100 may also implement speech generation models, including text-to-speech (TTS) systems using autoregressive or non-autoregressive architectures, and audio diffusion models capable of generating high-fidelity waveforms conditioned on linguistic and prosodic features. Feature extraction components may preprocess audio data to create Mel-spectrograms or other representations used during model training using the pre-training components 104.

Specialty server devices within the generative AI system 100, such as those of the distributed server infrastructure 114, may include GPUs, TPUs, or custom AI accelerators designed for high-throughput operations supporting both transformer and diffusion model training. These servers may differ from ordinary servers by incorporating high-bandwidth memory (HBM), advanced interconnects (e.g., NVLink, PCIe Gen5), and thermal and power management systems optimized for large-scale generative model workloads.

The generative AI system 100 may store shard-specific checkpoints, intermediate latents, and optimizer states for large-scale diffusion models, LLMs, and multimodal models on high-speed local or network-attached storage within the specialty servers, enabling resumption of training and inference jobs after interruptions or updates.

The fine-tuning components 106 of the generative AI system 100 may adapt generative models to specific user tasks or domain tasks, such as personalized content generation, domain-specific summarization, image style transfer, or voice cloning. Fine-tuning may involve supervised fine-tuning on task-specific datasets and reinforcement learning with human feedback (RLHF) where applicable, with data and gradients distributed across server devices for scalable operation.

The interfacing layers 108 of the generative AI system 100 may handle user prompts for LLM-based text generation, text-to-image generation requests, and speech synthesis requests. The system may tokenize or encode user prompts, generate conditioning latents where applicable (e.g., CLIP embeddings for image generation), and distribute inference tasks across server clusters for each modality-specific generative model. The interfacing layers 108 may include computer scripts, subroutines, or integrated tools for processing prompts, implementing models, and/or performing API calls to supplement and/or augment generative functions of LLMs and other models of the generative AI system 100. In some embodiments, the interfacing layers 108 include databases for accessing stored content (e.g., a vector database of content vectors for comparing with prompt vectors or query vectors) for contextual augmentation of model operation (e.g., for retrieval-augmented generation and its analogs). In some embodiments, the interfacing layers 108 integrate functionality from third-party systems (e.g., external to the generative AI system 100 and/or the distributed server infrastructure 114) into the generative AI system 100 using APIs and/or particular communication protocols to interact with generative model data (e.g., to execute generated code).

As illustrated in FIG. 1, the generative AI system 100 generates generative output 110. The generative AI system 100 can generate the generative output 110 in the form of text responses, images, videos, audio clips, or other multimodal digital content. The generative AI system 100 can generate the generative output 110 using the interfacing layers 108 in conjunction with one or more trained (e.g., pre-trained and fine-tuned, using the described components) generative models, including LLMs and others described herein.

In some embodiments, the generative AI system 100 generates the generative output 110 over one or more conversational interactions or turns with client device(s) 112. Indeed, the generative AI system 100 can provide the generative output 110 for display on the client device(s) 112. In addition, the generative AI system 100 can receive additional input in the form of text-based queries or prompts, images, videos, audio clips, and/or other multimodal content as part of an ongoing conversation between the generative AI system 100 and the client device(s) 112 and/or as part of a new conversation or instantiation of the generative AI system 100.

For large generative models exceeding single-device memory, the generative AI system 100 may implement model parallelism, with different server devices processing partitions of the model during inference across the distributed server infrastructure 114, and may use activation checkpointing and memory recomputation strategies to handle resource constraints efficiently across distributed modalities.

Server devices within the generative AI system 100 may utilize high-bandwidth interconnects for low-latency tensor and latent exchange during multi-stage generation processes (e.g., latent generation followed by decoding in diffusion models). This enables the generative AI system 100 to support complex, multi-step generation tasks, such as generating text and subsequently generating images conditioned on the generated text, while maintaining low latency.

The distributed server infrastructure 114 of the generative AI system 100 may include compute clusters with racks of specialty servers interconnected with high-bandwidth networking technologies such as InfiniBand, RDMA-enabled Ethernet, or custom fabrics, and distributed storage using NVMe over Fabrics (NVMe-oF) for rapid access to large model weights, intermediate outputs, and context data during inference.

The distributed server infrastructure 114 can include safety filtering and content moderation layers that operate in parallel with inference pipelines across modalities, applying token-level filtering for LLM outputs, image or video classification for generated visual content, and audio analysis for speech outputs to ensure outputs comply with operational policies and applicable regulations.

The distributed server infrastructure 114 can include orchestration and resource management layers that dynamically allocate compute, memory, and network resources across modalities, scaling generative model training and inference in response to user demand and system load while monitoring resource health across components of the generative AI system 100.

Collectively, the architecture illustrated in FIG. 1 enables the generative AI system 100 to provide scalable, efficient, and safe generative model services across text, image, video, audio, and other modalities, leveraging specialty server devices and distributed computing for high-throughput training, fine-tuning, and inference across a wide variety of generative AI applications.

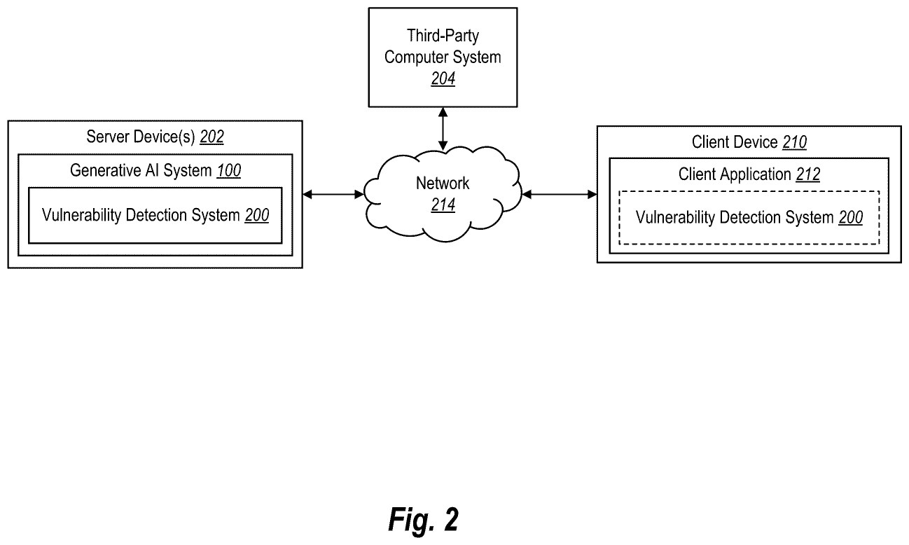

FIG. 2 illustrates a schematic diagram of an example system environment for implementing a vulnerability detection system in accordance with one or more implementations. An overview of the vulnerability detection system is described in relation to FIG. 2.

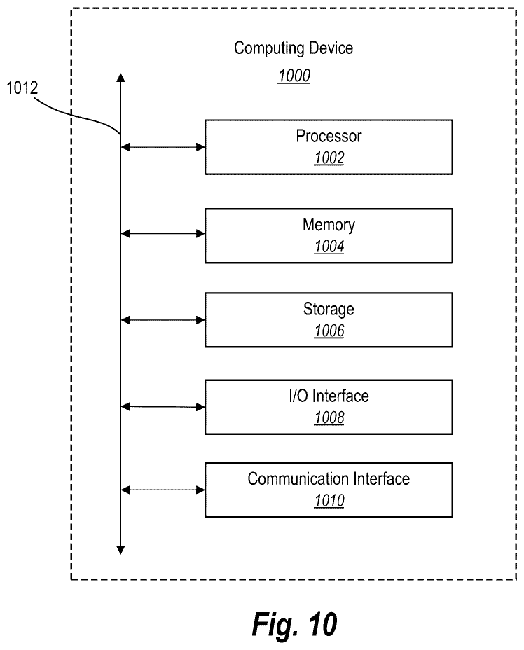

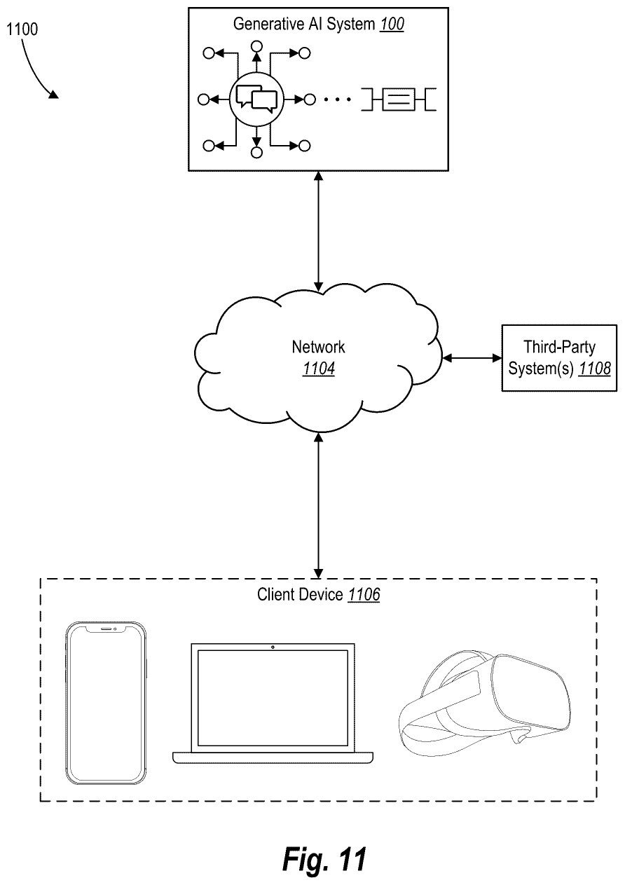

As shown, the environment includes server device(s) 202, a third-party computer system 204, a client device 210, and a network 214. Each of the components of the environment can communicate via the network 214, and the network 214 may be any suitable network over which computing devices can communicate. Example networks are discussed in more detail below in relation to FIGS. 10-11.

As mentioned above, the example environment includes a client device 210. The client device 210 can be one of a variety of computing devices, including a smartphone, a tablet, a smart television, a desktop computer, a laptop computer, a virtual reality device, an augmented reality device, or another computing device as described in relation to FIGS. 10-11. The client device 210 can communicate with the server device(s) 202 via the network 214. For example, the client device 210 can receive user input from a user interacting with the client device 210 (e.g., via the client application 212) to, for instance, interact with a generative AI system 100 located on the server device(s) 202. In addition, the vulnerability detection system 200 on the server device(s) 202 can receive information relating to various interactions with user interface elements based on the input received by the client device 210.

As shown, the client device 210 can include a client application 212. In particular, the client application 212 may be a web application, a native application installed on the client device 210 (e.g., a mobile application, a desktop application, etc.), or a cloud-based application where all or part of the functionality is performed by the server device(s) 202. Based on instructions from the client application 212, the client device 210 can present or display information, including a threat object, a validated threat object, a dialogue or a thread between a client device associated with a user and the large language model.

As illustrated in FIG. 2, the example environment also includes the server device(s) 202. The server device(s) 202 may generate, track, store, process, receive, search, communicatively link, and transmit electronic data, such as digital content (e.g., content items), datasets, messages, searchable data, pages of data, prompts, user queries, interface elements, external tools, commits, threat objects, interactions with interface elements, and/or interactions between user accounts or client devices and the generative AI system 100. For example, the server device(s) 202 may receive data from the client device 210 in the form of a user query. Additionally, the device(s) 202 can process inputs through the large language model and return generated outputs such as text, summaries, accessible tools, code, threat objects, threat risk scores, directed graphs, annotated directed graphs, videos, audio, or images. In some embodiments, the device(s) 202 manage auxiliary tasks such as session tracking, context management, content filtering, and integration with databases or external tools. Indeed, the server device(s) 202 can communicate with the client device 210 to send and/or receive data via the network 214. In some implementations, the server device(s) 202 comprise(s) a distributed server where the server device(s) 202 include(s) a number of server devices distributed across the network 214 and located in different physical locations. The server device(s) 202 can comprise one or more content servers, application servers, communication servers, web-hosting servers, machine learning servers, and other types of servers.

As shown in FIG. 2, the server device(s) 202 can also include the vulnerability detection system 200 as part of a generative AI system 100. The generative AI system 100 can communicate with the client device 210 to perform various functions associated with the client application 212, such as receiving user queries, scanning a code base, and/or resolving merge commits. In one or more cases, the vulnerability detection system 200 can perform tasks on a third-party computer system 204 that is connected to the generative AI system 100. The generative AI system 100 ingests structured or unstructured input data from respective data sources and/or codebases and uses the large language model to generate a threat model and intelligently produce outputs, threat objects, and/or recommended actions for addressing vulnerabilities in computer code.

Although FIG. 2 depicts the vulnerability detection system 200 located on the server device(s) 202, in some implementations, the vulnerability detection system 200 may be implemented by (e.g., located entirely or in part on) one or more other components of the environment. For example, the vulnerability detection system 200 may be implemented by the client device 210 and/or a third-party device. For example, the client device 210 can download all or part of the vulnerability detection system 200 for implementation independent of, or together with, the server device(s) 202. In some embodiments, the vulnerability detection system 200 is implemented as a plug-in or modular extension associated with the large language model.

As shown in FIG. 2, the example environment also includes a third-party computer system 204. In one or more embodiments, the third-party computer system is external to the device(s) 202 and stores data, commits, and/or computer code associated with the third-party computer system 204. As shown in FIG. 2, in one or more cases, the third-party computer system 204 can communicate with the server device(s) 202 over the network 214. In one or more embodiments, the third-party computer system 204 can communicate with the generative AI system 100 or the vulnerability detection system via a connector connecting the third-party computer system 204 to the generative AI system 100.

In some implementations, though not illustrated in FIG. 2, the environment may have a different arrangement of components and/or may have a different number or set of components altogether. For example, the client device 210 may communicate directly with the vulnerability detection system 200, bypassing the network 214. As another example, the environment can include a database located external to the server device(s) 202 (e.g., in communication via the network 214) or located on the server device(s) 202, on third-party servers, and/or on the client device 210.

As illustrated by the foregoing discussion, the present disclosure utilizes a variety of terms to describe features and benefits of the vulnerability detection system 200. Additional detail is provided hereafter regarding the meaning of these terms as used in the disclosure. As used herein, the term “commit” can include or refer to a unit of change to computer code. For example, a commit can reflect one or more changes (e.g., additions, deletions, modifications, etc.) to one or more files, functions, parameters, texts, objects, etc., of computer code associated with a computer application. In one or more cases, the vulnerability detection system 200 can record, track, and/or save modifications to computer code by storing one or more commits in a codebase (or source code repository). Thus, the vulnerability detection system 200 can utilize a commit to capture a state and/or version of the computer code. In one or more cases, a commit may have a unique identifier and/or metadata outlining a change, an author, a date, a committer, and/or one or more parent commits associated with the commit. In one or more cases, the commit can correspond to GitHub (or GitLab) as a Git commit. In one or more cases, the commit can correspond to Mercurial, Fossil, AWS CodeCommit, Apache Subversion, GNU Bazaar, or any other version control systems.

Relatedly, as used herein, the term “threat model” can include or refer to a model that defines security-relevant parameters and analyzes commits and/or modified functions based on the security-relevant parameters (e.g., vulnerability parameters and/or taint attributes). For example, in one or more cases, the threat model can include a structured data object that defines vulnerability parameters, such as, attack surfaces (e.g., APIs), vulnerability classes (e.g., SQL injection), and/or threat prioritization criteria (e.g., weights) associated with a commit and/or a modified function (or text) corresponding to the commit. In one or more cases, the vulnerability detection system 200 can tailor a threat model based on the program type of the code base. For example, the attack surfaces for the codebase of a web service can differ from the attack surfaces of a codebase of a CLI. In one or more cases, the threat model can be a machine-learning model, a neural network, or a large language model. In one or more embodiments, the threat model can be an algorithm or statistical model. Moreover, in some cases, the threat model can be a heuristic or a rule-based model. Additionally, the threat model can provide context about the vulnerabilities of the computer code.

Moreover, as used herein, the term “generative threat analysis agent” can include or refer to an agent that analyzes the risk and/or threats associated with vulnerabilities within the computer code of a computer application. In one or more cases, the generative threat analysis agent can be a large language model that applies weights and/or heuristics to one or more functions associated with a commit to generate a risk score associated with the commit.

As used herein, the term “generative model” refers to a machine learning model that is configured to generate new data samples that are statistically consistent with the data on which the model was trained. Generative models may include, but are not limited to, large language models, diffusion models, variational autoencoders, generative adversarial networks, and multimodal transformer models. Generative models may be configured to generate outputs across various modalities, including text, images, audio, and video, either independently or conditionally based on input data from the same or a different modality. For example, a generative model may generate an image based on a textual prompt, generate speech based on textual input, or generate text based on prior conversational context, and may operate using probabilistic or iterative denoising methods to produce high-quality, contextually appropriate outputs.

As used herein, the term “large language model” (or “LLM”) refers to a computational model configured to process and generate human-readable text by learning statistical and contextual relationships within natural language data using machine learning techniques. An LLM typically comprises a deep neural network architecture, such as a transformer-based architecture with multiple layers and attention mechanisms, and is trained on large corpora of text using objectives such as masked language modeling, causal language modeling, or autoregressive prediction. The LLM may include billions or trillions of parameters and is capable of performing a variety of language tasks, including but not limited to text generation, summarization, translation, and question answering, by generating outputs based on input prompts in a contextually relevant manner.

Relatedly, the term “machine learning model” refers to a computational construct comprising one or more algorithms and associated parameters that are configured to perform tasks by identifying patterns or relationships within data. A machine learning model may be trained using supervised, unsupervised, semi-supervised, or reinforcement learning techniques, where the model parameters are adjusted based on input data to minimize a loss function or maximize a reward signal. The machine learning model may include, but is not limited to, neural networks (e.g., convolutional neural networks, recurrent neural networks, transformer models), decision trees, support vector machines, or ensemble models, and may be configured to perform tasks such as classification, regression, clustering, anomaly detection, or data generation. A machine learning model may operate on structured, unstructured, or multimodal data and may generate outputs that are used for predictions, decisions, or content generation based on learned representations of input data.

Additionally, the term “neural network” refers to a computational model comprising multiple interconnected processing elements, often referred to as neurons or nodes, that are organized into layers, including an input layer, one or more hidden layers, and an output layer. Each neuron in the neural network applies a transformation, which may include a weighted sum of inputs followed by a non-linear activation function, to produce an output that is transmitted to subsequent neurons in the network. Neural networks are configured to learn representations of data by adjusting the weights and biases of the connections between neurons during a training process that minimizes a loss function. The neural network may include various architectures, including but not limited to feedforward neural networks, convolutional neural networks (CNNs), recurrent neural networks (RNNs), and transformer-based networks (e.g., LLMs), and may be utilized for tasks such as classification, regression, pattern recognition, natural language processing, and generative modeling across structured, unstructured, or multimodal data.

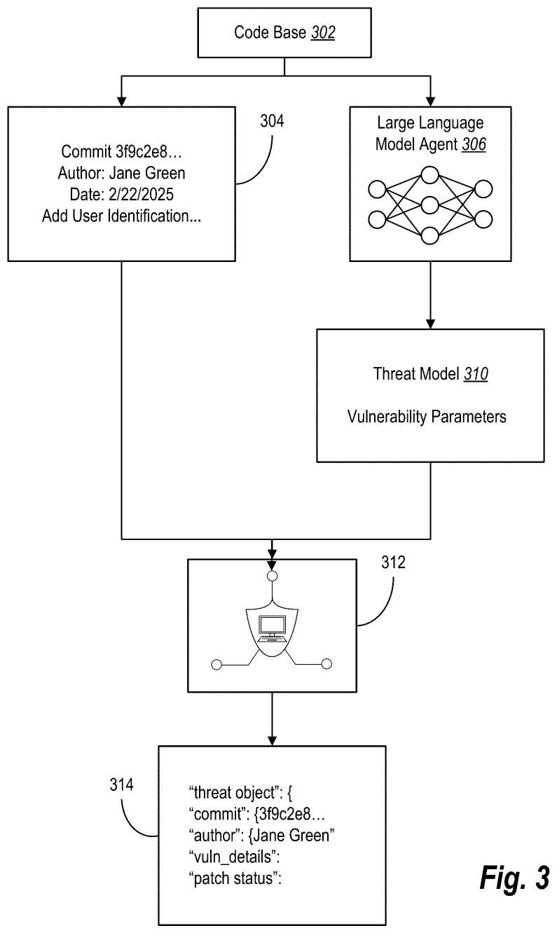

As mentioned above, the generative AI system 100 can detect vulnerabilities associated with changes to computer code in a computer application. FIG. 3 illustrates the example overview of a vulnerability detection system 200 generating a threat object in accordance with one or more embodiments. Additional detail regarding the acts and processes introduced in relation to FIG. 3 is provided thereafter with reference to subsequent figures.

As shown in FIG. 3, the generative AI system 100 (or the vulnerability detection system 200) can retrieve or detect a commit 304 from a codebase 302. For example, in some cases, the vulnerability detection system 200 can store commits related to and/or defining computer code changes saved for a computer application. For example, the codebase 302 can include a list, tree, directory, index, etc., comprising commits indicating changes and/or modifications to functions, text, parameters, bugs, and/or files. For example, in some cases, the commit 304 can correspond to a snapshot of a state of a file, function, text, etc., within computer code associated with the computer application.

As further shown in FIG. 3, the vulnerability detection system 200 can utilize a large language model agent 306 associated with or within the generative AI system 100 to generate a threat model 310. In one or more cases, the large language model agent 306 can scan or analyze the commit 304 and/or the codebase 302 to determine a program type associated with the commit 304, the computer code, and/or the computer application. For example, the program type associated with the commit 304, the computer code, and/or computer application could be a web service, Command-Line Interface (CLI), library, and/or kernel module. In one or more cases, the large language model agent 306 can identify the program type and generate the threat model 310 that corresponds to the program type of the commit 304.

In one or more cases, the large language model agent 306 can generate the threat model 310 with a structured data object that defines the vulnerability parameters of the computer code associated with the computer application. In some cases, the vulnerability parameters of the threat model 310 can define likely attack surfaces, relevant vulnerability classes, and/or threat prioritization criteria related to the commit 304, the computer code, and/or the computer application. In one or more cases, the vulnerability detection system 200 can utilize an external environment to inform the generation of the threat model 310. In particular, the vulnerability detection system 200 can utilize the external environment to identify known issues (e.g., attack surfaces and/or vulnerability classes) for a given program type of the codebase 302, the computer code, and/or the computer application. In one or more embodiments, the vulnerability detection system 200 can receive, via a client device associated with a user account, user supplied information identifying issues or vulnerabilities within the codebase 302 and the vulnerability detection system 200 can generate or inform generation of the threat model based on the user supplied information.

As further shown in FIG. 3, the vulnerability detection system 200 can utilize the commit 304 and the threat model 310 to generate a threat object 314. In particular, the vulnerability detection system 200 can utilize a generative threat analysis agent 312 to analyze the commit 304 and the threat model 310 together to determine if the commit 304 exposes the computer application to various threats and/or security risks. For example, the generative threat analysis agent 312 can detect a vulnerability associated with the commit 304 and determine the severity (or risk) of the vulnerability associated with the commit 304 and/or a likelihood of the vulnerability being leveraged by a bad actor and/or an external artificial intelligence agent. In some cases, the vulnerability detection system 200 can prioritize the vulnerability associated with the commit 304 based on the type of vulnerability.

As FIG. 3 illustrates, the generative threat analysis agent 312 can generate a threat object 314 indicating threat data associated with the commit 304. For example, the threat object 314 can include a description of the vulnerability associated with the commit 304. In some cases, the threat object 314 can identify the severity, impact, location, patch status, etc., of the vulnerability associated with the commit 304. For example, upon determining that the commit 304 corresponding to modifying a function within the computer code leads to a vulnerability that opens the computer application to risks or threats, the threat object 314 can indicate the location, degree of severity (e.g., high, moderate, or low), and/or whether the vulnerability detection system 200 has implemented a fix (or patch) to the modified function to address and/or remove the vulnerability. For example, the threat object 314 can include an explanation of the methods, timing, and effectiveness for patching the vulnerability. Indeed, the vulnerability detection system 200 can identify existing vulnerabilities and patched vulnerabilities that were patched in the source code but not in the detection system. In some cases, the threat object 314 can be a JSON artifact comprising the threat data.

As suggested above, the vulnerability detection system 200 can provide several improvements or advantages over existing threat analysis systems. In particular, the vulnerability detection system 200 can provide increased security over existing threat analysis systems. For example, the vulnerability detection system 200 can isolate vulnerability analysis from the control plane of the system, preventing prompt injection and other attacks that could contaminate orchestration logic or compromise sensitive data associated with the control plane. By performing code analysis within isolated worker environments, the vulnerability detection system 200 avoids the risks of directly processing commits in the control plane and ensures the integrity of security decisions. Moreover, the vulnerability detection system 200 can utilize schema enforcement and output sanitization to produce structured, reliable findings, thereby preventing inaccurate or corrupted results that might otherwise weaken security posture.

On top of improved security, the vulnerability detection system 200 can provide increased flexibility. For example, the vulnerability detection system 200 can dynamically generate threat models tailored to the program type of a codebase, enabling the system to perform language-agnostic vulnerability analysis across heterogeneous repositories. Unlike traditional tools bound to fixed parsers, abstract syntax trees, or hard-coded rules, the vulnerability detection system 200 can reliably extract functions from unstructured code, resolve indirect function calls, and operate effectively across multiple programming languages, frameworks, and application types. Such flexibility enables the system to adapt to evolving software environments and accurately identify vulnerabilities in diverse codebases.

In addition to improved security and flexibility, the vulnerability detection system 200 can deliver enhanced computational efficiency compared to conventional approaches. In particular, the vulnerability detection system 200 can perform commit-driven analysis that avoids re-scanning entire repositories, instead focusing only on new or modified code while maintaining full historical context through merge commit resolution. Moreover, the vulnerability detection system 200 can parallelize its analysis across isolated containers, allowing it to scale efficiently to large repositories and complex change histories. Such parallelism and targeted scanning reduce redundant computation, lower runtimes, and improve scalability in continuous integration and deployment pipelines.

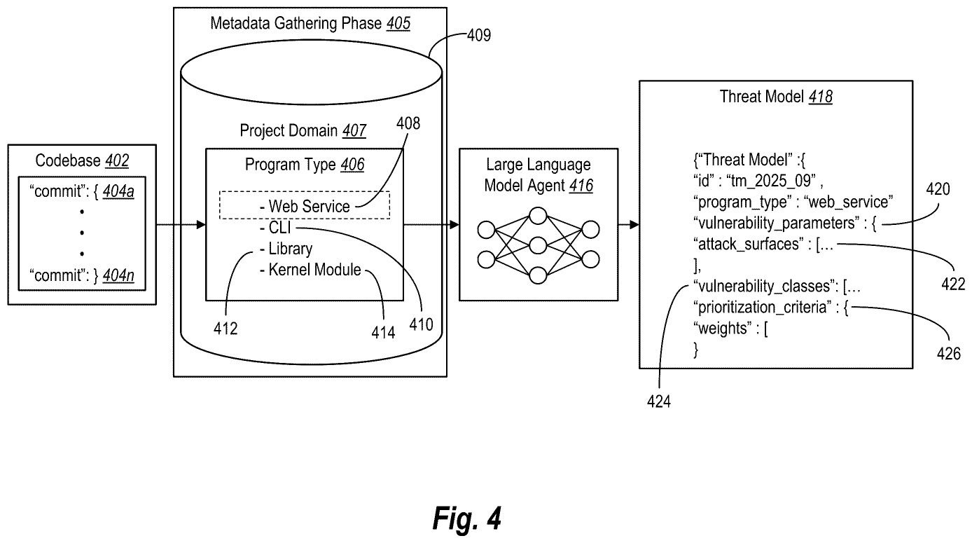

As just discussed, the vulnerability detection system 200 can detect vulnerabilities within computer code according to a threat model. In particular, the vulnerability detection system 200 can define a threat model to identify and/or expose bugs or changes that open the computer code to security risks. In one or more cases, the vulnerability detection system 200 can utilize the program type of the computer code and/or the computer application to generate (or select) a threat model. FIG. 4 illustrates the vulnerability detection system 200 generating a threat model in accordance with one or more embodiments.

As shown in FIG. 4, the vulnerability detection system 200 can scan a codebase 402 that stores one or more commits 404a-n. As indicated above, the codebase can include a history and/or index of all of the changes, states, and/or versions of the computer code by storing the one or more commits 404a-n that reflect such changes. As further shown in FIG. 4, the vulnerability detection system 200 can implement a metadata gathering phase 405 where the vulnerability detection system 200 collects information about a project domain 407 and metadata (e.g., program type 406) associated with the commits 404a-n. For example, in one or more cases, the vulnerability detection system 200 can gather information from a repository 409 (e.g., mono repository) storing information about project domains (e.g., Sora, ChatGPT, etc.), metadata, source code, etc., associated with the generative AI system 100. For example, the vulnerability detection system 200 can select the project domain 407 associated with ChatGPT and provide metadata and additional information about the project domain 407 to the large language model agent 416 where the large language model agent 416 can generate the threat model 418 with vulnerability parameters 420 that are specific to the project domain 407. Thus, the vulnerability detection system 200 can generate an individualized threat model customized and specific to the project domain 407.

As shown in FIG. 4, in one or more cases, the metadata gathering phase 405 can include determining a program type 406 of the codebase 402 based on the scan. For example, the vulnerability detection system 200 can determine that the program type 406 of the codebase 402 is a web service 408, a command-line interface (or CLI 410), a library 412, or a kernel module 414. For example, based on the formatting, location, and/or structure, the vulnerability detection system 200 can determine that the program type (or version control system) of the codebase 402 is the library 412 (e.g., software library). In some cases, the vulnerability detection system 200 can receive one or more user inputs indicating the program type 406 of the codebase 402 or the computer code of the computer application.

As FIG. 4 further illustrates, the vulnerability detection system 200 can utilize the project domain 407, the program type 406, and/or the one or more commits 404a-n, and a large language model agent 416 to generate a threat model 418. In some cases, the large language model agent 416 can be a large language model working with an agent to generate the threat model 418. In some cases, the vulnerability detection system 200 can utilize a large language model to generate the threat model 418. For example, based on the project domain 407 and the commit metadata (e.g., program type 406), the large language model agent 416 can generate the threat model 418 that defines the vulnerability parameters 420 specific to the program type 406. For example, the vulnerability detection system 200, via the large language model agent 416, can define relevant (or likely) attack surfaces 422, relevant (or applicable) vulnerability classes 424, and/or threat prioritization criteria 426 of the threat model 418 specific to the program type 406. For example, the large language model agent 416 can define (or identify) relevant HTTP endpoints (or APIs) for the web service 408, relevant system calls (syscalls) for the kernel module 414. In one or more cases, the large language model agent 416 can perform multiple passes over the project domain 407, commit metadata, and/or external environmental data to generate the threat model 418, evaluating its own performance each pass and determining whether to proceed with additional passes to improve results.

Additionally, the large language model agent 416 can define relevant vulnerability classes 424 (e.g., common weakness enumeration classes) associated with each program type 406. For example, the large language model agent 416 can define relevant SQL injections (SQLi) or Cross-Site Scripting (XSS) for the threat model 418 tailored to the web service 408 program type 406. To further illustrate, the large language model agent 416 can define relevant vulnerability classes 424, such as improper input validations or improper authorizations for the threat model 418 tailored to the CLI 410 program type 406. In some cases, the vulnerability detection system 200 can further utilize an Open Web Application Security Project (OWASP) and/or Software Fault Patterns (SFPs) to determine the relevant vulnerability classes 424.

Moreover, the large language model agent 416 can define the threat prioritization criteria 426 based on the program type 406. In one or more cases, the threat prioritization criteria 426 can be a scoring framework that weighs the importance of vulnerabilities associated with the one or more commits 404a-n. For example, the threat prioritization criteria 426 can define how the threat model 418 weighs the severity (or criticality) of the relevant vulnerability classes 424, the likelihood (or reachability) of triggering the vulnerability, the sensitivity of the data (e.g., PII, authentication logic, payment flows, etc.) related to the vulnerability, and/or the exploitability of the vulnerability. To further illustrate, the vulnerability detection system 200 can weigh the exploitability of the vulnerability based on the availability and/or knowledge of exploitative techniques. In one or more cases, the threat prioritization criteria 426 for the library 412 program type 406 can differ from the threat prioritization criteria 426 of the CLI 410 program type 406.

In one or more cases, the vulnerability detection system 200 can receive one or more user inputs modifying the threat model 418, or more specifically, the structured data object defining the vulnerability parameters 420. For example, the vulnerability detection system 200 can receive one or more user interactions adding, removing, and/or modifying the relevant attack surfaces 422 and/or the relevant vulnerability classes 424. In one or more cases, the vulnerability detection system 200 can receive one or more user inputs modifying the relevant vulnerability classes 424 by adding and/or removing likely common weakness enumeration (CWE) classes. Moreover, the vulnerability detection system 200 can receive one or more user inputs modifying the threat prioritization criteria 426 of the threat model 418. For example, the vulnerability detection system 200 can receive one or more user interactions increasing and/or decreasing the weights for the severity of the relevant vulnerability classes 424, the likelihood of triggering the vulnerability, the sensitivity of the data, and/or the exploitability of the vulnerability. In one or more cases, based on receiving the one or more user interactions modifying the vulnerability parameters 420, the vulnerability detection system 200 can update the threat model 418 and/or the vulnerability parameters 420 of the threat model 418.

In some cases, the vulnerability detection system 200 can save the threat model 418 or additional threat models and select (or initialize) the saved threat model in a subsequent analysis. For example, if the vulnerability detection system 200 generated the threat model 418 for the codebase 402 with the web service 408 program type 406 and received an additional commit for the codebase 402, the vulnerability detection system 200 could select the threat model 418 tailored to the web service 408 program type 406 and utilize the threat model 418 through a vulnerability threat analysis pipeline to analyze the additional commit. Indeed, the vulnerability detection system 200 can generate a database comprising a plurality of threat models that can be selected and initiated based on the program type 406 of the codebase 402.

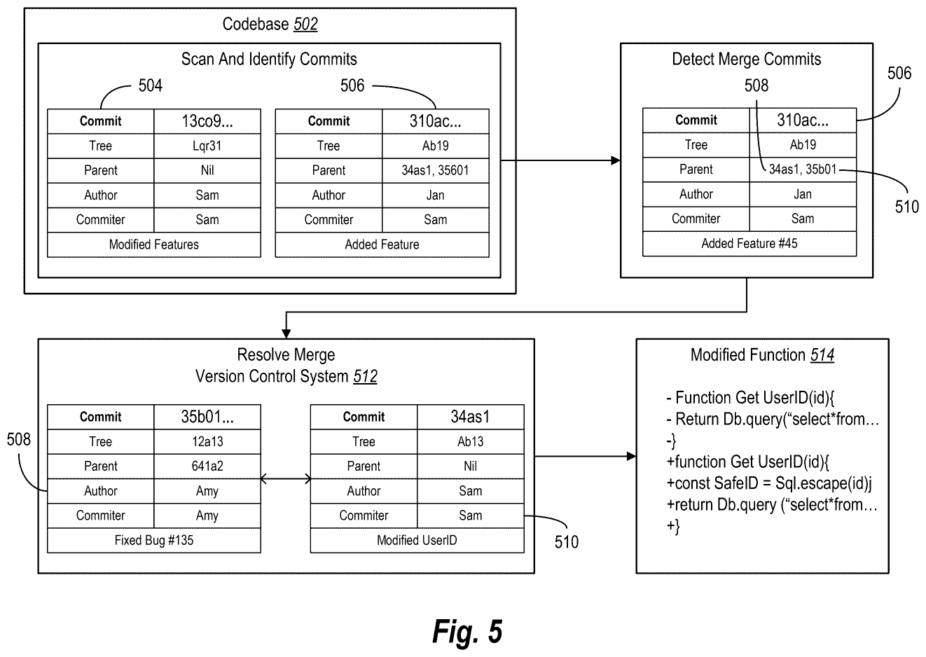

As just discussed, the vulnerability detection system 200 can generate a threat model tailored to a program type of a codebase that stores one or more commits that reflect changes to the computer code of a computer application. In some cases, the vulnerability detection system 200 can process different types of commits, such as merge commits that have multiple parent commits, so that the threat model can accurately detect and/or determine one or more vulnerabilities associated with different types of commits (e.g., merge commits). FIG. 5 illustrates the vulnerability detection system 200 resolving merge commits in accordance with one or more embodiments.

As shown in FIG. 5, the vulnerability detection system 200 can scan a codebase 502. In some cases, the vulnerability detection system 200 can scan and identify a commit 504 or scan a range of commits in the codebase 502. For example, the vulnerability detection system 200 can scan the range of commits comprising the commit 504 and an additional commit 506. In some cases, the range of commits can correspond to a pull request. In one or more embodiments, the vulnerability detection system 200 can analyze the data (or metadata) associated with the commit 504 and/or the additional commit 506 to determine if the commit 504 and/or the additional commit 506 is a single commit or a merge commit. In one or more embodiments, a single non-merge commit (e.g., commit 504) has a single parent commit and records a linear change to the codebase 502. In some cases, a merge commit (e.g., additional commit 506) has two or more parent commits and combines at least two branches (or histories) of changes of the codebase 502. In one or more cases, the vulnerability detection system 200 can analyze hundreds to hundreds of millions of commits within the codebase 502 by identifying single commits and resolving merge commits.

As shown in FIG. 5, the vulnerability detection system 200 can detect merge commits by identifying commits that have two or more parent commits. For example, as shown in FIG. 5, the vulnerability detection system 200 detects that additional commit 506 is a merge commit because it has two parent commits (e.g., a first parent commit 508 and a second parent commit 510).

As further shown in FIG. 5, the vulnerability detection system 200 can resolve the merge commit (e.g., additional commit 506) by utilizing a version control system 512. For example, the vulnerability detection system 200 can traverse parent commits in a version-control directed acyclic graph (DAG) to resolve merge commits. To further illustrate, the vulnerability detection system 200 can identify the first parent commit 508 and the second parent commit 510 utilizing the version control system 512. In one or more cases, the vulnerability detection system 200 can trigger the version control system 512 to traverse the parents commits (e.g., the first parent commit 508 and the second parent commit 510). For example, the vulnerability detection system 200 can utilize a git rev-parse command to drill down into the first parent commit 508 and the second parent commit 510 to generate a list of single commits. Indeed, the vulnerability detection system 200, unlike conventional vulnerability analysis systems, can enumerate and analyze all of the changes introduced by combining branches and/or states of the codebase 502 by analyzing single commits (e.g., commit 504) and merge commits (e.g., additional commit 506). In one or more cases, the version control system 512 can include and/or utilize subversion (SVN) or Mercurial (Hg). Moreover, the version control system 512 can be a centralized version control system (VCS), a distributed VCS, and/or a local VCS. Thus, the vulnerability detection system 200 can enable accurate and broad coverage of changes in complex histories of the codebase 502.

As further shown in FIG. 5, the vulnerability detection system 200 can extract modified files, functions, objects, parameters, texts, etc., associated with the commits in the codebase 502. For example, the vulnerability detection system 200 can detect one or more modified files in the commit 504 and/or the additional commit 506 (e.g., via the first parent commit 508 and the second parent commit 510) and further identify one or more modified functions (e.g., modified function 514) or modified code regions of the computer code. For example, based on analyzing the first parent commit 508, the vulnerability detection system 200 can identify the location (e.g., file, function, and/or line) of the modified function 514. In one or more cases, the modified function 514 can include a code difference snippet showing the modified function 514 before and after applying the first parent commit 508. For example, the modified function 514 shows the application of a sanitization step based on the first parent commit 508. Indeed, the vulnerability detection system 200 can extract one or more modified functions, files, etc., associated with the commit 504, the additional commit 506, the first parent commit 508, and/or the second parent commit 510 showing changes applied to the computer code and/or the codebase 502.

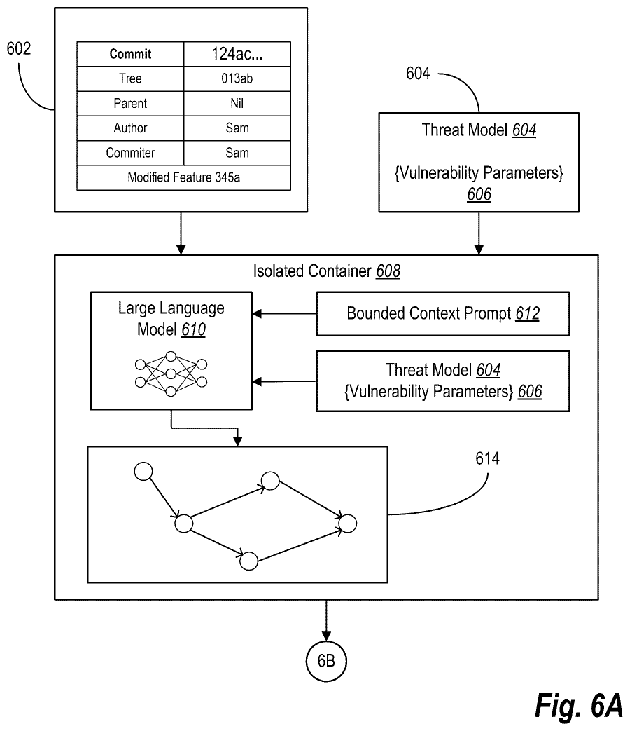

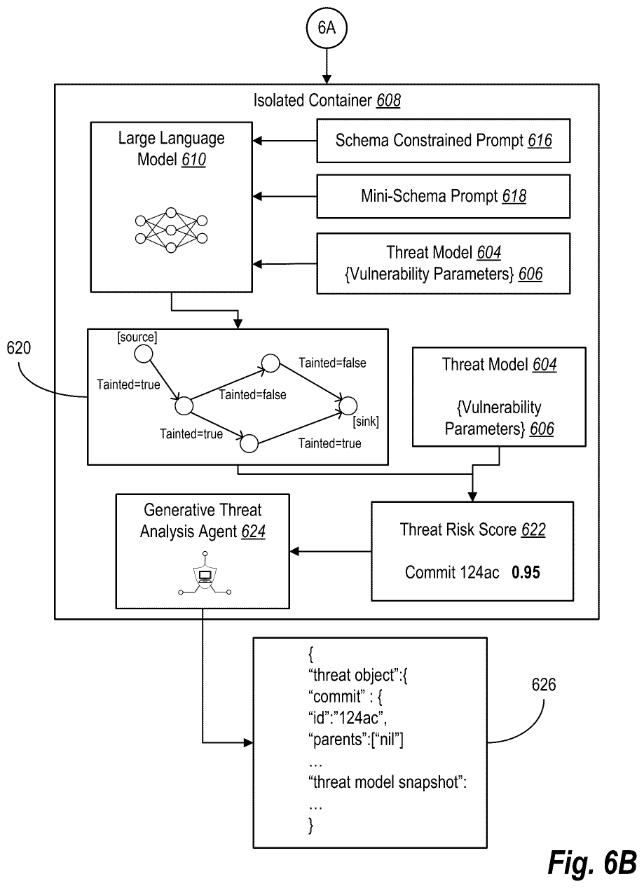

As just discussed, the vulnerability detection system 200 can analyze changes to computer code on a commit basis to identify all modifications to the computer code and codebase. In one or more cases, the vulnerability detection system 200 can further analyze the commits and/or modified functions, modified files, modified texts, etc., to generate a threat object indicating vulnerabilities within the computer code. FIGS. 6A-6B illustrate the vulnerability detection system 200 generating a threat object by analyzing a commit within an isolated container in accordance with one or more embodiments. In particular, FIG. 6A illustrates the vulnerability detection system 200 generating a directed graph utilizing a bounded context prompt in accordance with one or more embodiments.

As shown in FIG. 6A, the vulnerability detection system 200 can generate an isolated container 608 for analyzing a commit 602, or more particularly, one or more modified functions, files, objects, etc., associated with the commit 602 as described above in FIG. 5. In one or more cases, the isolated container 608 is an isolated execution environment (or isolated capability-gated container or virtual machine) that prevents a large language model and/or agent (e.g., generative threat analysis agent) that is performing analysis on the commit 602 (or the one or more modified functions) from accessing control-plane code, configuration, and/or secrets. Additionally, the isolated container 608 is isolated from the control plane used by the large language model and/or large language model agent. In one or more cases, the isolated container 608 controls access of the generative threat analysis agent to a subset of codebase (or a snippet of code) comprising and/or related to the commit 602. In one or more embodiments, the isolated container 608 is ephemeral and enforces a declared capability policy including file, network, and/or process privileges. Moreover, FIG. 6A shows an embodiment where the vulnerability detection system 200 utilizes a single isolated container. In one or more cases, the vulnerability detection system 200 can utilize any number of isolated containers ranging from one to billions of isolated containers that analyze one or more commits (or one or more modified functions) in parallel. Thus, the vulnerability detection system 200 can enable massive parallelization of commit analysis.

As discussed above, the vulnerability detection system 200 can analyze the commit 602 (or the one or more modified functions associated with the commit 602) and the threat model 604 with a large language model 610 (or large language model agent) in the isolated container 608. In one or more cases, the vulnerability detection system 200 can utilize the threat model 604 to provide context to the large language model 610 regarding which relevant attack surfaces and/or vulnerability classes to focus on or highlight, and how to prioritize findings. Indeed, the threat model 604 can inform the large language model 610 on what to look for while analyzing the commit 602 (or the one or more modified functions associated with the commit 602). For example, the large language model 610 can utilize (or propagate) the threat model 604 at each stage (or step) to guide the analysis of the large language model 610. In one or more cases, analyzing the commit 602 can include linearizing a commit range in reverse topological order and skipping analysis for commits with previously validated threat data that remains present.

In one or more embodiments, the vulnerability detection system 200 can enumerate functions of the codebase by utilizing a large language model 610 to traverse the codebase to identify files based on a curated extension list or one or more heuristic filters. Moreover, the vulnerability detection system 200 can inform the large language model 610 with a structured prompt to request a list of function definitions (e.g., name, location, boundaries, arguments, return variables, internal calls to other functions, etc.) for each of the one or more files within the codebase and/or computer code. In some implementations, the vulnerability detection system 200 can parse an output or response of the large language model under a strict schema (e.g., JSON or XML), enabling language-agnostic discovery of the functions without language-specific parsing. In some cases, the vulnerability detection system 200 can enumerate all the functions within the code base or a subset of functions within the code base. In one or more cases, the vulnerability detection system 200 can utilize the threat model 604 so that the large language model 610 can highlight a subset of functions associated with relevant attack surfaces or relevant vulnerability classes for further downstream analysis.

As further shown in FIG. 6A, the vulnerability detection system 200 can analyze the commit 602 and associated vulnerabilities utilizing the threat model 604 in the isolated container 608 by generating a directed graph of the functions (including the modified functions) associated with the commit 602 and/or additional commits within the codebase. For example, the vulnerability detection system 200 can utilize a bounded context prompt 612 (or one or more bounded context prompts) instructing the large language model 610 to generate the directed graph 614 of the functions. For example, in one or more cases, the vulnerability detection system 200 can extract a bounded code snippet (e.g., 100 kB or less) for each enumerated (or identified) function and provide the bounded code snippet along with the bounded context prompt 612 (e.g., “List DIRECT callees in JSON array”) to the large language model 610. In one or more cases, the vulnerability detection system 200 can parse the first JSON array from the output (or response) of the large language model 610. Additionally, the vulnerability detection system 200 can construct the directed graph 614 where the one or more functions become nodes in the directed graph 614.

In one or more cases, the vulnerability detection system 200 can generate directed edges (e.g., F→callee) for each callee of the one or more functions. In some cases, the vulnerability detection system 200 can utilize a NetworkX graph (or network.DiGraph) from Python to store the directed edges of the directed graph 614. Additionally, the vulnerability detection system 200 can utilize checkpoints to enable resumability and increase scale and fault tolerance. For example, the vulnerability detection system 200 can persist intermediate snapshots (e.g., callgraph.json) after processing a batch of files and/or functions to generate the directed graph 614 so that the vulnerability detection system 200 does not need to re-query the large language model 610 for already processed functions.

As just discussed, the vulnerability detection system 200 can generate the directed graph. FIG. 6B illustrates the vulnerability detection system 200 generating a threat object based in part on analyzing an annotated directed graph with a threat model in accordance with one or more embodiments. In one or more cases, as shown in FIG. 6B, the vulnerability detection system 200 can further annotate the directed graph 614 with one or more taint attributes. In particular, the vulnerability detection system 200 can annotate (or classify) the nodes and/or directed edges of the directed graph 614 with the one or more taint attributes by utilizing the threat model 604. For example, in one or more cases, the vulnerability detection system 200 can further analyze the one or more functions of the directed graph 614 by inputting the bounded code snippet of the one or more functions into the large language model 610 and processing the code snippet of the one or more functions according to a schema constrained prompt 616 (or a node schema constrained prompt). For example, the constrained prompt 616 can request for each function, a yes or no response to whether the function is a data source (or source), a sink, or tainted out (e.g., a data flow that feeds tainted data from a source to a sink).

In one or more cases, the large language model 610 can act as a semantic classifier determining if the function is a source that reads from an untrusted input, is a sink that writes to sensitive resources, and/or a tainted out that returns variables related to the function that remain unsafe. Moreover, the large language model 610 can utilize the threat model 604 to define which functions act as sources or sinks. In some cases, the vulnerability detection system 200 can parse outputs from the large language model 610 with an XML fixer so that the output of the large language model 610 is well-formed. The vulnerability detection system 200 can further coerce values to expected types. As shown in FIG. 6B, the vulnerability detection system 200 can add the one or more taint attributes to the nodes representing the functions.

Additionally, as shown in FIG. 6B, the vulnerability detection system 200 can annotate the directed edges of the directed graph 614 with one or more taint attributes. In one or more cases, the vulnerability detection system 200 can input a caller function, a callee function, and the corresponding argument lists, along with a mini-schema prompt 618 (or edge schema constrained prompt) into the large language model 610. For example, the mini-schema prompt can read, “{“arg_map”: {}, “tainted_in”: [], “propagate”: {}, “tainted_flow”: bool }.” In one or more cases, the large language model 610 can generate an output (or response) indicating whether taint passes across a data flow from the caller arguments to the callee parameters. In some cases, the vulnerability detection system 200 can enforce deterministic outputs (e.g., temperature=0) and/or apply a sanitizer to coerce types and/or output a valid JSON. As shown in FIG. 6B, the vulnerability detection system 200 can annotate the directed edges of the directed graph 614 with the one or more taint attributes (e.g., tainted_in, propagate, or tainted_flow). For example, annotating the directed edges can indicate if taint flows between a function caller and a function callee. As described in more detail below, the vulnerability detection system 200 can utilize the threat model 604 and annotation of functions and/or the one or more modified functions as sources or sinks to determine whether taint propagates across an edge.

In one or more cases, the vulnerability detection system 200 can apply parameter-level propagation to an annotated directed graph 620 to determine if taint moves through the annotated directed graph 620. In particular, the vulnerability detection system 200 can apply a deterministic algorithm to propagate taint from caller parameters to callee parameters. For example, the vulnerability detection system 200 can start at a source function and follow the directed edges of the annotated directed graph 620. In one or more cases, the vulnerability detection system 200 can mark tainted callee parameters by applying the “arg_map” and “propagate” attributes to the annotated directed graph 620 and determine if the callee functions return a tainted variable. If a callee function from the callee functions returns a tainted variable, the vulnerability detection system 200 can mark the callee function as tainted and/or a vulnerability. Thus, in one or more cases, directed edges propagating a vulnerability (or taint) from a source function to a sink function are candidates for exposing the vulnerabilities of a computer application for malicious misuse.

As further shown in FIG. 6B, the vulnerability detection system 200 can rank the risk associated with the one or more functions (or modified functions) identified in the annotated directed graph 620 as vulnerabilities by generating a threat risk score 622 for the function (or commit associated with the function). In particular, the vulnerability detection system 200 can utilize the threat model 604 comprising a structured data object defining one or more vulnerability parameters 606 to process the commit 602 and/or the one or more functions and/or the one or more modified functions (or modified files). For example, the vulnerability detection system 200 can determine a threat risk score 622 for the commit 602 and/or the one or more modified functions associated with the commit 602 based on the one or more vulnerability parameters 606 of the threat model 604.

For example, the vulnerability detection system 200 can utilize the threat prioritization criteria of the threat model 604 to apply weights and/or additional heuristics to each function from the annotated directed graph 620 to generate the threat risk score 622 for each of the one or more modified functions associated with the commit 602. For example, the vulnerability detection system 200 can utilize the severity, likelihood, sensitivity, exploitability, etc., to generate the threat risk score 622. In some cases, the vulnerability detection system 200 can determine the threat risk score 622 based on aggregating taint attributes with a model-estimated exploitability score. In one or more cases, the vulnerability detection system 200 can rank the one or more modified functions according to corresponding threat risk scores. As further shown in FIG. 6B, the vulnerability detection system 200 can select a subset of modified functions for additional analysis by a generative threat analysis agent 624. For example, the vulnerability detection system 200 can select the top-N functions for deeper analysis by the generative threat analysis agent 624.

As just mentioned, the vulnerability detection system 200 can utilize the generative threat analysis agent 624 to analyze high-risk functions (or high-risk modified functions). In some cases, the vulnerability detection system 200 can generate (or spawn) a fresh large language model agent (e.g., the generative threat analysis agent 624) per high-risk function. In some cases, the vulnerability detection system 200 can make available various tools (e.g., helper tools) that the generative threat analysis agent 624 can call to return one or more functions (or modified functions) that expose the computer application to security threats. For example, the vulnerability detection system 200 can utilize a first tool call (e.g., xref_tool(function, direction, depth)) to return a JSON list of callers/callees associated with the commit 602 and/or the one or more modified functions. Moreover, the generative threat analysis agent 624 can utilize a second tool call (e.g., taint_path_tool(function)) to return the shortest source-to-function taint path (or data flow) of the one or more modified functions. In one or more cases, the generative threat analysis agent 624 can invoke the tools calls and analyze the subset of high-risk functions according to the context provided by the threat model 604 and the one or more vulnerability parameters 606 to generate a threat object 626 indicating threat data associated with the commit 602, or more particularly, one or more modified functions associated with the commit 602. In some cases, the generative threat analysis agent 624 can invoke external tools selected from one or more static analyzers, one or more symbolic execution engines, and/or one or more fuzzers to generate the threat object 626. For example, the generative threat analysis agent 624 can combine (or merge) one or more outputs from the one or more static analyzers, the one or more symbolic execution engines, and/or the one or more fuzzers to generate the threat object 626.

As shown in FIG. 6B, in one or more cases, the generative threat analysis agent 624 can generate the threat object 626 as an XML block comprising threat data reflecting the criticality, description, and/or bugs related to the commit 602 (or the one or more modified functions associated with the commit 602). For example, the threat object 626 can include information about the vulnerability class (e.g., CWE class), the severity/likelihood of a bad actor leveraging the modified function, evidence indicating a specific taint path (or data flow), list of callers/callees, and/or a recommended fix (or patch) addressing the vulnerability associated with the commit 602. Indeed, the vulnerability detection system 200 can generate a structured output (e.g., threat object 626) that makes triaging vulnerabilities faster and easier.

In some implementations, the vulnerability detection system 200 can generate a JSON artifact of the threat object 626 and post the threat object 626 to a communication channel (e.g., Slack channel), a disk, a web interface, and/or an API. In some cases, the threat object 626 can include evidence artifacts selected from program slices, call paths, taint traces, stack traces, prof0of-conept inputs, and/or execution logs. As described in more detail below, in one or more cases, the vulnerability detection system 200 can receive one or more user inputs about the findings associated with the threat object 626. In some cases, vulnerability detection system 200 can filter the threat object 626 with an additional large language model or heuristic model based on security relevance before publishing the threat object 626 to the communication channel, the web interface, etc. In one or more implementations, the vulnerability detection system 200 can generate a set of threat objects associated with analyzing the commit 602 in the isolated container. Additionally, in some cases, the vulnerability detection system 200 can generate a set of threat objects for a range (or plurality) of commits based on the vulnerability detection system 200 performing parallel analysis of the range of commits across a set of isolated containers. Additionally, in some cases, the vulnerability detection system 200 can rank the set of threat objects for presentation and/or review in a code review system. Indeed, the vulnerability detection system 200 can rank and provide for display one or more threat objects for review or for mediation within the code review system.

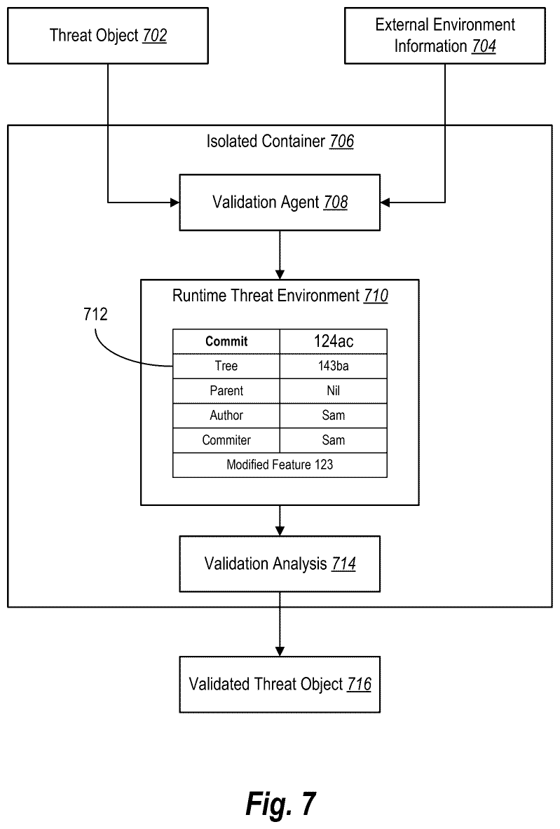

As just described, the vulnerability detection system 200 can generate a threat object indicating threat data associated with a commit. In some cases, the vulnerability detection system 200 can validate the threat object before publishing the threat object to the communication channel, the web interface, etc., to confirm the vulnerability associated with the commit and further understand the impact and risk associated with the commit. FIG. 7 illustrates the vulnerability detection system 200 validating a threat object utilizing a validation agent in accordance with one or more embodiments.

As shown in FIG. 7, the vulnerability detection system 200 can generate an isolated container 706 (or an additional isolated container). In one or more cases, the isolated container 706 is an isolated CaaS container that prevents interference with control-plane code or other environments. Moreover, in some cases, the isolated container 706 is a short-lived, capability-gated container where the validation agent 708 has no access to control-plane code, configurations, and/or secrets. As shown in FIG. 7, the vulnerability detection system 200 can analyze a threat object 702 and external environment information 704 with a validation agent 708 within the isolated container 706. In some cases, the external environment information 704 can provide external information about the runtime threat environment 710. In particular, the vulnerability detection system 200 can generate a runtime threat environment 710 by cloning the commit 712, one or more modified functions associated with the threat object 702 (or commit), caller/caller paths, etc., associated with the threat object 702 in a debug configuration. For example, as shown in FIG. 7, the vulnerability detection system 200 can generate a cloned version of the commit based on the threat object 702.

As further shown in FIG. 7, the vulnerability detection system 200 can execute the runtime threat environment 710 and perform validation analysis 714 on the runtime threat environment 710. For example, the vulnerability detection system 200 can apply the relevant proof-of-concept (POC) or a test harness associated with the vulnerability (or bug) and run the runtime threat environment 710 under analysis tools (e.g., Valgrind, sanitizers, etc.) to detect one or more vulnerabilities. For example, the validation agent 708 can detect memory safety errors, such as, but not limited to, buffer overflows, race conditions, and/or out-of-bounds reading/writing.

In one or more cases, the validation agent 708 can detect other flaw types, such as, but not limited to, injection and data flow flaws (e.g., SQL injection, command injection, cross-site scripting), authentication and access controls (e.g., improper authentication), and resource management (e.g., improper input validation). In some cases, the validation analysis 714 can include fuzz payloads, taint replay, and/or symbolic execution to confirm vulnerabilities. In some cases, the validation agent 708 can perform the validation analysis 714 based on the program type (e.g., CLI, library, kernel modules, web). For example, for the cloned version of the commit 712 associated with a kernel module program type, the validation analysis 714 can utilize an analyzer or test specific to the kernel module program type.

Thus, the validation agent 708 can utilize the validation analysis 714 to trace vulnerability conditions across multiple functions (e.g., modified functions) and/or files (e.g., modified files) associated with the cloned version of the commit 712. Additionally, in one or more cases, the validation agent 708 can further process fixed commits by checking the parent commit to recreate a vulnerable state associated with the cloned version of the commit 712 before the fix (or patch). For example, the vulnerability detection system 200 can recreate a parent commit of a fixed commit in the runtime threat environment 710 and analyze, utilizing the validation agent 708, the execution of the recreated parent commit and/or the fixed commit.

In one or more embodiments, the vulnerability detection system 200 can confirm the presence of threat data in the recreated parent and the absence of the threat data in the fixed commit by executing the recreated parent and the fixed commit within the runtime threat environment 710. In one or more cases, the vulnerability detection system 200 can confirm the threat data associated with the fixed commit by confirming a vulnerability associated with the recreated parent commit. In one or more cases, the validation analysis 714 can act as a code simulation to compile and run commits to test for bugs in the codebase that lead to vulnerabilities. For example, in one or more cases, the validation agent 708 can detect a bug associated with a commit and included in the threat object 702 that feeds or leads to a vulnerability in the codebase. Thus, the validation analysis 714 can confirm (or verify) the existence of a bug (or one or more bugs) defined in the threat object 702.

In one or more cases, the vulnerability detection system 200 can confirm the existence of the vulnerability associated with the commit based on the validation agent 708 reproducing the vulnerability in the isolated container 706. For example, the vulnerability detection system 200 can determine if a payload from a source reached a sink without going through a sanitizer. The vulnerability detection system 200 can generate a validated threat object 716 based on the validation agent 708 confirming the vulnerability associated with the cloned version of the commit 712. In one or more cases, if the validation agent 708 and the validation analysis 714 do not reproduce the vulnerability associated with the cloned version of the commit 712, the vulnerability detection system 200 can mute or deprioritize the vulnerability associated with the cloned version of the commit 712. Additionally, in some cases, validating (or revalidating) the threat object 702 (or threat data) can determine if the identified vulnerability (or threat data) exists in a default branch tip. In one or more cases, if the identified vulnerability (or threat data) does not exist in the default branch tip, the vulnerability detection system 200 can suppress an alert of the vulnerability of (the threat data).

As indicated above, in one or more cases, the validated threat object 716 can be a structured output comprising threat data (or validated threat data) associated with the cloned version of the commit 712. For example, the validated threat object 716 can include validation logs, proof of concept source code (e.g., code snippet), and/or environment details. In some cases, the validated threat object 716 can include a validation status (e.g., success or failure) indicating confirmation of the vulnerability, along with a summary of the trigger conditions associated with the vulnerability. In one or more cases, the vulnerability detection system 200 can save the validated threat object 716 to a local disk as a JSON and send structured messages and/or reports based on the validated threat object 716 to a chat platform (e.g., Slack), an API endpoint, and/or to a web interface.

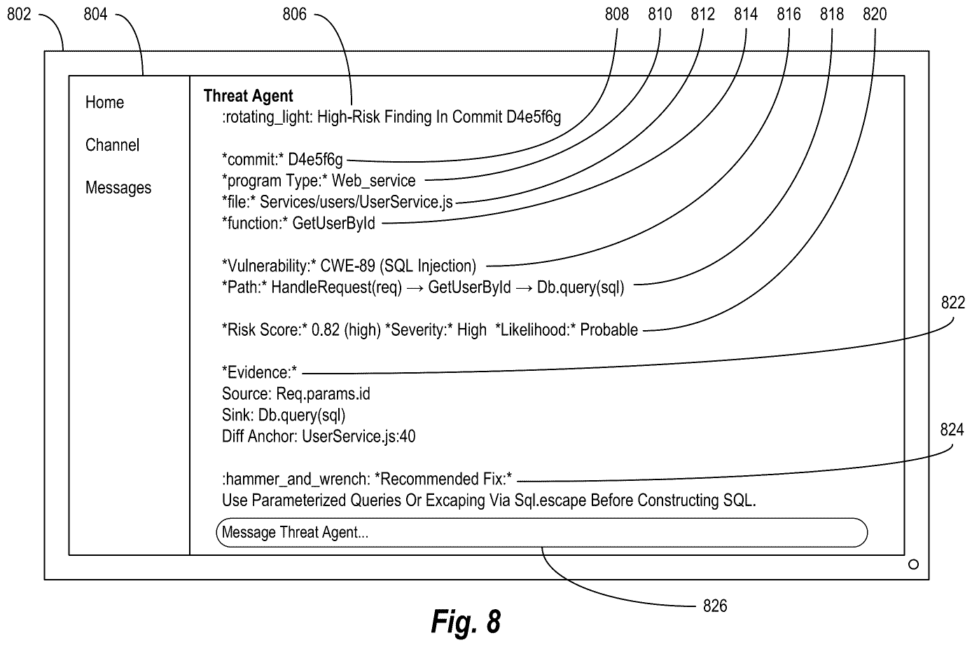

As just discussed, the vulnerability detection system 200 can generate a threat object and/or a validated threat object that outlines threat data associated with a commit. The vulnerability detection system 200 can further provide and modify a graphical user interface for reviewing commits associated with a threat object. FIG. 8 illustrates an exemplary graphical user interface presenting a threat object (or validated threat object) in accordance with one or more embodiments.

As shown in FIG. 8, the vulnerability detection system 200 can provide for display on a graphical user interface 804 of a client device 802 a threat object 806 (or a message associated with the threat object 806). As shown in FIG. 8, the threat object 806 can include information identifying a commit 808, a program type 810, a file 812, a function 814, a vulnerability 816, an execution path 818, and/or a risk score 820. Indeed, the threat object 806 can inform a user account associated with the commit 808, the codebase, the computer code, and/or the computer application of important information about the vulnerability 816 associated with the commit 808. In one or more cases, the threat object 806 takes on a JSON format. Additionally, the threat object 806 (or a message associated with the threat object 806) can follow the static analysis result interchange format (SARIF) to report vulnerabilities. In some cases, the vulnerability detection system 200 can utilize the threat object 806 to generate a SARIF-compliant report.

In one or more cases, the threat object 806 or (message associated with the threat object 806) can include evidence 822 about the vulnerability 816 associated with the commit 808. For example, the risk score 820 can include a source and sink (or caller/callee) associated with the function and/or the execution path.

Indeed, the threat object 806 can provide a human-readable name and a clear summary and/or explanation of the vulnerability 816 and associated commit 808. In some cases, the threat object 806 can indicate the severity or level of risk associated with the vulnerability and the impact of the vulnerability on the affected computer code. In some cases, the threat object 806 can include information about how the vulnerability 816 can be exploited. In one or more cases, the threat object 806 can indicate the location and whether the vulnerability 816 is patched, unpatched, and/or under review. In one or more embodiments, the threat object 806 can include a common vulnerability ranking (CVS) as indicated by industry standards to rank the risk of the vulnerability.

As further shown in FIG. 8, the threat object 806 or (message associated with the threat object 806) can include a recommended action 824 for addressing the vulnerability 816. For example, the vulnerability detection system 200 can suggest tests and/or patches to apply to functions (or the computer code) based on the vulnerability class associated with the vulnerability. For example, the vulnerability detection system 200 can generate the recommended action 824 for addressing SQL injection flaws. In some cases, a validation agent, as described above in FIG. 7, can validate the recommended action 824 and confirm whether the recommended action 824 (or fix) addresses the vulnerability.

As further shown in FIG. 8, the vulnerability detection system 200 can receive one or more user interactions via an input field 826. In some cases, the vulnerability detection system 200 can support an interactive chat, via a large language model and/or agent (e.g., generative threat analysis agent or validation agent), about one or more findings included in the threat object 806. For example, the vulnerability detection system 200 can receive one or more user inputs requesting more information about the risk score 820 and/or the one or more vulnerability parameters associated with the threat model. In some cases, the vulnerability detection system 200 can modify and/or update the threat object 806 to highlight or include information deemed important by the user account based on receiving the one or more user interactions. In some cases, the vulnerability detection system 200 can formulate the threat object 806 based on the preferences of the user account generating and/or utilizing the threat object 806.

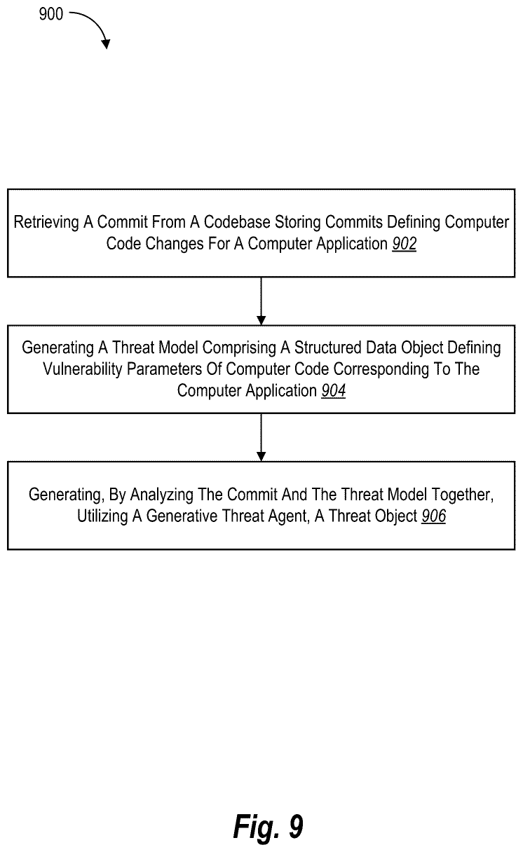

FIGS. 1-8, the corresponding text, and the examples provide a number of different systems and methods for detecting vulnerabilities and potential threats in a codebase based on commits defining computer code changes saved for a computer application. In addition to the foregoing, implementations can also be described in terms of flowcharts comprising acts or steps in a method for accomplishing a particular result. For example, FIG. 9 illustrates an example series of acts performed by the vulnerability detection system 200 in accordance with one or more embodiments.

While FIG. 9 illustrates acts according to certain implementations, alternative implementations may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In still further implementations, a system can perform the acts of FIG. 9.

As illustrated in FIG. 9, a series of acts 900 may include an act 902 of retrieving a commit from a codebase storing commits defining computer code changes saved for a computer application, an act 904 of generating a threat model comprising a structured data object defining vulnerability parameters of computer code corresponding to the computer application, and an act 906 of generating by analyzing the commit and the threat model together, utilizing a generative threat analysis agent, a threat object.

In particular, the act 902 includes retrieving, by a generative artificial intelligence (AI) system, a commit from a codebase storing commits defining computer code changes saved for a computer application. Further, the act 904 includes generating, utilizing a large language model of the generative AI system, a threat model comprising a structured data object defining vulnerability parameters of computer code corresponding to the computer application. Moreover, the act 906 includes generating, by analyzing the commit and the threat model together utilizing a generative threat analysis agent, a threat object indicating threat data associated with the commit.

Further, in one or more embodiments, the series of acts 900 includes enumerating computer code changes for the computer application by resolving merge commits from the codebase storing commits, wherein resolving the merge commits comprises traversing parent commits utilizing a version control system.

Additionally, in one or more embodiments, the series of acts 900 includes generating the threat object by utilizing the generative threat analysis agent in an isolated container, wherein the isolated container controls access of the generative threat analysis agent to a subset of codebase comprising the commit.

In one or more cases, the series of acts 900 includes determining modified functions impacted by the commit. Moreover, in one or more embodiments, the series of acts 900 includes generating, utilizing one or more bounded context prompts informing the large language model, a directed graph mapping function calls of the modified functions. In some implementations, the series of acts 900 includes annotating, utilizing one or more schema-constrained prompts informing the large language model, the function calls and the modified functions with taint attributes based on at least one of data sources, sinks, or data flows of the function calls and the modified functions. In one or more cases, the series of acts 900 can include determining a threat risk score for the commit based on annotating the function calls and the modified functions with the taint attributes.

Additionally, in some implementations, the series of acts 900 can include building a runtime threat environment comprising a cloned version of the commit from the computer code based on the threat object. Furthermore, in one or more embodiments, the series of acts 900 includes generating a validated threat object indicating a confirmation of the threat data associated with the commit based on analyzing an execution of the cloned version of the commit within the runtime threat environment.

Moreover, the series of acts 900 can include determining a program type associated with the codebase. In some implementations, the series of acts includes generating the threat model based on the program type.

Additionally, in one or more embodiments, the series of acts 900 includes retrieving, by a generative artificial intelligence (AI) system, a commit from a codebase storing commits defining computer code changes saved for a computer application. Moreover, in one or more embodiments, the series of acts 900 includes generating, utilizing a large language model of the generative AI system, a threat model comprising a structured data object defining vulnerability parameters of computer code corresponding to the computer application. Further, in one or more embodiments, the series of acts 900 includes generating, utilizing the large language model, a threat risk score for the commit based on analyzing the commit and the threat model. Moreover, in one or more embodiments, the series of acts 900 includes generating, utilizing a generative threat analysis agent, a threat object indicating threat data associated with the commit based on the threat risk score for the commit.

Further, in one or more embodiments, the series of acts 900 includes resolving merge commits from the codebase storing commits by traversing parent commits.

In some cases, the series of acts 900 can include identifying the vulnerability parameters of computer code corresponding to at least one of relevant attack surfaces of the codebase, relevant vulnerability classes of the codebase, or threat prioritization criteria of the threat model. In one or more implementations, the series of acts 900 includes receiving one or more user inputs modifying at least one of the relevant attack surfaces of the codebase, the relevant vulnerability classes of the codebase, or the threat prioritization criteria of the threat model. Moreover, in one or more embodiments, the series of acts 900 includes updating the vulnerability parameters based on the one or more user inputs.

Further, in one or more embodiments, the series of acts 900 includes generating the threat object by utilizing the generative threat analysis agent in an isolated capability-gated container, wherein the isolated capability-gated container controls access of the generative threat analysis agent to a subset of codebase comprising the commit.

In one or more embodiments, the series of acts 900 can include determining a modified function associated with the commit. In some cases, the series of acts 900 includes generating, utilizing one or more bounded context prompts informing the large language model, a directed graph mapping function calls of the modified function. Moreover, in one or more embodiments, the series of acts 900 includes annotating, utilizing one or more schema-constrained prompts informing the large language model, the function calls and the modified function with taint attributes. Further, in one or more embodiments, the series of acts 900 includes determining the threat risk score for the commit based on annotating the function calls and the modified function.

Additionally, in one or more embodiments, the series of acts 900 includes building a runtime threat environment comprising a recreated parent commit of a fixed commit from the computer code. Further, in one or more embodiments, the series of acts 900 includes validating the threat object by analyzing, utilizing a validation agent, an execution of the recreated parent commit within the runtime threat environment by indicating a confirmation of the threat data associated with the fixed commit.

Further, in one or more embodiments, the series of acts 900 includes determining a program type associated with the codebase storing commits defining computer code changes saved for the computer application. Additionally, in some implementations, the series of acts 900 includes generating the threat model based on the program type.

Furthermore, in one or more embodiments, the series of acts 900 can include retrieving, by a generative artificial intelligence (AI) system, a range of commits from a codebase storing commits defining computer code changes saved for a computer application. Moreover, in one or more embodiments, the series of acts 900 includes generating, utilizing a large language model of the generative AI system, a threat model comprising a structured data object defining vulnerability parameters of computer code corresponding to the computer application. Further, in one or more embodiments, the series of acts 900 includes generating, by analyzing the range of commits and the threat model together utilizing a generative threat analysis agent, a set of threat objects indicating threat data associated with the range of commits.

Moreover, in one or more embodiments, the series of acts 900 includes resolving merge commits by traversing parent commits utilizing a version control system.

In some cases, the series of acts 900 can include an act where the vulnerability parameters of the computer code correspond to at least one of relevant attack surfaces of the codebase, relevant vulnerability classes of the codebase, or threat prioritization criteria of the threat model.

Moreover, in one or more embodiments, the series of acts 900 includes generating the set of threat objects by utilizing the generative threat analysis agent in an isolated container, wherein the isolated container controls access of the generative threat analysis agent to a subset of codebase comprising the range of commits.

Additionally, the series of acts 900 can include determining modified functions associated with the range of commits defining the computer code changes. Further, in one or more embodiments, the series of acts 900 includes generating, utilizing one or more bounded context prompts informing the large language model, a directed graph mapping function calls of the modified functions. Moreover, in one or more embodiments, the series of acts 900 includes annotating the function calls and the modified functions with taint attributes based on at least one of data sources, sinks, or data flows of the function calls and the modified functions. Moreover, in one or more embodiments, the series of acts 900 includes determining a threat risk score for the range of commits based on the annotating the function calls and the modified functions.

Additionally, in one or more implementations, the series of acts 900 can include building a runtime threat environment comprising a cloned commit of a commit from the range of commits based on the set of threat objects. Further, in one or more embodiments, the series of acts 900 includes detecting one or more threats by analyzing an execution of the cloned commit within the runtime threat environment. In one or more cases, the series of acts 900 can include generating a validated threat object indicating a confirmation of the threat data associated with the commit.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media. Non-transitory computer-readable storage media (devices) includes RAM, ROM, EEPROM, solid state drives (“SSDs”) (e.g., based on RAM), Flash memory, phase-change memory (“PCM”), or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network computers, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server device(s) 202 and/or the client device 210) that may be configured to perform one or more of the processes described above. One will appreciate that server device(s) 202 and/or the client device 210 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 is a schematic diagram illustrating environment 1100 within which one or more implementations of the vulnerability detection system 200 can be implemented. For example, the vulnerability detection system 200 may be part of a generative AI system 100 (e.g., the generative AI system 100). Generative AI system 100 may generate, store, manage, receive, and send digital content (such as digital content items). For example, generative AI system 100 may send and receive digital content to and from client devices 1106 by way of network 1104. In particular, generative AI system 100 can store and manage a collection of digital content. Generative AI system 100 can manage the sharing of digital content between computing devices associated with a plurality of users. For instance, generative AI system 100 can facilitate a user sharing a digital content with another user of generative AI system 100.

In particular, generative AI system 100 can manage synchronizing digital content across multiple client devices 1106 associated with one or more users. For example, a user may edit digital content using client device 1106. The generative AI system 100 can cause client device 1106 to send the edited digital content to generative AI system 100. Generative AI system 100 then synchronizes the edited digital content on one or more additional computing devices.

In addition to synchronizing digital content across multiple devices, one or more implementations of generative AI system 100 can provide an efficient storage option for users that have large collections of digital content. For example, generative AI system 100 can store a collection of digital content on generative AI system 100, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full-or high-resolution version of digital content from generative AI system 100. In particular, upon a user selecting a reduced-sized version of digital content, client device 1106 sends a request to generative AI system 100 requesting the digital content associated with the reduced-sized version of the digital content. Generative AI system 100 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access generative AI system 100.

As illustrated, the generative AI system 100 communicates with third-party system(s) 1108 by way of the network 1104. For example, the generative AI system 100 generates computer code or scripts for execution by the third-party system(s) 1108 as part of generating an output. In some cases, the generative AI system 100 integrates subcomponents or features of the third-party system(s) 1108 using APIs or other integrations. The third-party system(s) 1108 can include systems housed and operated on servers separate from the generative AI system 100, such as data management systems, calendaring systems, social networking systems, search engine systems, and/or computer other systems.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
retrieving, by a generative artificial intelligence (AI) system, a commit from a codebase storing commits defining computer code changes saved for a computer application;
generating, utilizing a large language model of the generative AI system, a threat model comprising a structured data object defining vulnerability parameters of computer code corresponding to the computer application; and
generating, by analyzing the commit and the threat model together utilizing a generative threat analysis agent, a threat object indicating threat data associated with the commit.

2. The computer-implemented method of claim 1, further comprising:
enumerating computer code changes for the computer application by resolving merge commits from the codebase storing commits, wherein resolving the merge commits comprises traversing parent commits utilizing a version control system.

3. The computer-implemented method of claim 1, wherein the vulnerability parameters of computer code correspond to at least one of relevant attack surfaces of the codebase, relevant vulnerability classes of the codebase, or threat prioritization criteria of the threat model.

4. The computer-implemented method of claim 1, further comprising:
generating the threat object by utilizing the generative threat analysis agent in an isolated container, wherein the isolated container controls access of the generative threat analysis agent to a subset of the codebase comprising the commit.

5. The computer-implemented method of claim 1, further comprising:
determining modified functions impacted by the commit;
generating, utilizing one or more bounded context prompts informing the large language model, a directed graph mapping function calls of the modified functions;
annotating, utilizing one or more schema-constrained prompts informing the large language model, the function calls and the modified functions with taint attributes based on at least one of data sources, sinks, or data flows of the function calls and the modified functions; and
determining a threat risk score for the commit based on annotating the function calls and the modified functions with the taint attributes.

6. The computer-implemented method of claim 1, further comprising:
building a runtime threat environment comprising a cloned version of the commit from the computer code based on the threat object; and
generating a validated threat object indicating a confirmation of the threat data associated with the commit based on analyzing an execution of the cloned version of the commit within the runtime threat environment.

7. The computer-implemented method of claim 1, further comprising:
determining a program type associated with the codebase; and
generating the threat model based on the program type.

8. A system comprising:
at least one processor; and
a non-transitory computer-readable medium storing instructions which, when executed by the at least one processor, cause the system to:
retrieve, by a generative artificial intelligence (AI) system, a commit from a codebase storing commits defining computer code changes saved for a computer application;
generate, utilizing a large language model of the generative AI system, a threat model comprising a structured data object defining vulnerability parameters of computer code corresponding to the computer application;
generate, utilizing a generative threat analysis agent, a threat risk score for the commit based on analyzing the commit and the threat model; and
generate, utilizing the generative threat analysis agent, a threat object indicating threat data associated with the commit based on the threat risk score for the commit.

9. The system of claim 8 further comprising instructions, which when executed by the at least one processor cause the system to resolve merge commits from the codebase storing commits by traversing parent commits.

10. The system of claim 8, further comprising instructions, which when executed by the at least one processor cause the system to:
identify the vulnerability parameters of computer code corresponding to at least one of relevant attack surfaces of the codebase, relevant vulnerability classes of the codebase, or threat prioritization criteria of the threat model;
receive one or more user inputs modifying at least one of the relevant attack surfaces of the codebase, the relevant vulnerability classes of the codebase, or the threat prioritization criteria of the threat model; and
update the vulnerability parameters based on the one or more user inputs.

11. The system of claim 8, further comprising instructions, which when executed by the at least one processor cause the system to: generate the threat object by utilizing the generative threat analysis agent in an isolated capability-gated container, wherein the isolated capability-gated container controls access of the generative threat analysis agent to a subset of codebase comprising the commit.

12. The system of claim 8, further comprising instructions, which when executed by the at least one processor cause the system to:
determine a modified function associated with the commit;
generate, utilizing one or more bounded context prompts informing the large language model, a directed graph mapping function calls of the modified function;
annotate, utilizing one or more schema-constrained prompts informing the large language model, the function calls and the modified function with taint attributes; and
determine the threat risk score for the commit based on annotating the function calls and the modified function.

13. The system of claim 8, further comprising instructions, which when executed by the at least one processor cause the system to:
build a runtime threat environment comprising a recreated parent commit of a fixed commit from the computer code; and
validate the threat object by analyzing, utilizing a validation agent, an execution of the recreated parent commit within the runtime threat environment by indicating a confirmation of the threat data associated with the fixed commit.

14. The system of claim 8, further comprising instructions, which when executed by the at least one processor cause the system to:
determine a program type associated with the codebase storing commits defining computer code changes saved for the computer application; and
generate the threat model based on the program type.

15. A non-transitory computer-readable medium storing executable instructions which, when executed by at least one processor, cause the at least one processor to:
retrieve, by a generative artificial intelligence (AI) system, a range of commits from a codebase storing commits defining computer code changes saved for a computer application;
generate, utilizing a large language model of the generative AI system, a threat model comprising a structured data object defining vulnerability parameters of computer code corresponding to the computer application; and
generate, by analyzing the range of commits and the threat model together utilizing a generative threat analysis agent, a set of threat objects indicating threat data associated with the range of commits.

16. The non-transitory computer-readable medium of claim 15, further storing instructions which, when executed by the at least one processor, cause the at least one processor to resolve merge commits by traversing parent commits utilizing a version control system.

17. The non-transitory computer-readable medium of claim 15, wherein the vulnerability parameters of the computer code correspond to at least one of relevant attack surfaces of the codebase, relevant vulnerability classes of the codebase, or threat prioritization criteria of the threat model.

18. The non-transitory computer-readable medium of claim 15, further storing instructions which, when executed by the at least one processor, cause the at least one processor to generate the set of threat objects by utilizing the generative threat analysis agent in an isolated container, wherein the isolated container controls access of the generative threat analysis agent to a subset of codebase comprising the range of commits.

19. The non-transitory computer-readable medium of claim 15, further storing instructions which, when executed by the at least one processor, cause the at least one processor to:
determine modified functions associated with the range of commits defining the computer code changes;
generate, utilizing one or more bounded context prompts informing the large language model, a directed graph mapping function calls of the modified functions;
annotate the function calls and the modified functions with taint attributes based on at least one of data sources, sinks, or data flows of the function calls and the modified functions; and
determine a threat risk score for the range of commits based on the annotating the function calls and the modified functions.

20. The non-transitory computer-readable medium of claim 15, further storing instructions which, when executed by the at least one processor, cause the at least one processor to:
build a runtime threat environment comprising a cloned commit of a commit from the range of commits based on the set of threat objects;
detect one or more threats by analyzing an execution of the cloned commit within the runtime threat environment; and
generate a validated threat object indicating a confirmation of the threat data associated with the commit.
